(19) United States
(12) Patent Application Publication
(10) Pub. No.: US 2014/0172718 A1
(43) Pub. Date: Jun. 19, 2014

(54) SYSTEM AND METHOD TO PROVIDE MEDICAL RECORD ACCESS VIA INTERNET ACCESSIBLE DEVICES

(71) Applicants: Po Leung Lui, Elmhurst, NY (US); Frank James Brown, Bronx, NY (US)

(72) Inventors: Po Leung Lui, Elmhurst, NY (US); Frank James Brown, Bronx, NY (US)

(21) Appl. No.: 13/716,176

(22) Filed: Dec. 16, 2012

(51) Int. Cl. G06F 19/00

(52) U.S. Cl. CPC G06F 19/322
USPC 705/51; 705/3

(57) ABSTRACT

A system and method to provide medical record access to existing vendor centric and legacy networks by way of a pass-through mechanism that can process multiple disparate digital credentials and encryption algorithms. The system and method utilize a health information exchange (HIE). The HIE comprises a plurality of nodes which are configured to connect to any node via a traditional wired network or wirelessly, wherein each node comprises a server and a communication gateway. Communicating with the HIE are a plurality of entities, wherein each entity has a server functionally connected to a communications gateway configured to communicate with the HIE.

### BACKGROUND OF THE INVENTION

### Field of the Invention

The present disclosure relates to systems and methods for providing the facilitation of credential authentication for medical record access and usage over non-interoperable networks. More particularly, to systems and methods for providing the access and usage via any computing environment with any form of Internet connectivity.

Currently, a wide range of disparate systems and methods are available to provide medical record access and usage. Unfortunately, the digital credentials and encryption algorithms of these systems and methods are incompatible and non-interoperable. Hence, medical records and their associated uses must be translated to a plurality of applications. This will result in greater inconvenience and cost for everyone.

### BRIEF SUMMARY OF THE INVENTION

A system to provide healthcare entities with agnostic internet accessible plug-in applications for accessing confidential medical records. The system comprises a plurality of nodes that are configured to communicate with each other, wherein each node comprises a server and a communication gateway; and a plurality of entities, wherein each entity has a server functionally connected to a communications gateway configured to communicate with any health information exchange (HIE).

A healthcare entity can be a hospital, public health organization, doctor's office, small healthcare providers, clinic, independent physician, emergency medical system, patient, employer or healthcare payer network, or the like.

A method to provide the facilitation of credential authentication medical record access comprises using a health information exchange. This comprises of a plurality of nodes which are configured to communicate with each other. Each node comprises a web service interface within a service oriented architecture (SOA) cloud (i.e. transport layer utilizing Simple Object Access Protocol (SOAP)), Representational State Transfer (REST); and using a plurality of entities. Each entity has a server functionally connected to a communications gateway configured to communicate with any health information exchange.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a block diagram of a typical computing environment used for implementing embodiments of the present disclosure.

FIG. 2 shows a high level view of the interaction between multiple institutions.

FIG. 3 shows an in-depth view of interaction between multiple institutions.

FIG. 4 shows a clinical messaging embodiment.

FIG. 5 shows an embodiment using the Cross-Enterprise Document Sharing (XDS.b) standard for query and document retrieval.

FIG. 6 shows an embodiment of medical entities utilizing ORMAP plug-in and OR Tech Server in the facilitation of medical data sharing between institutions running multiple credential authentication systems utilizing various encryption algorithms.

FIG. 7 shows an embodiment of high level architecture.

FIG. 8 shows the steps in a company registration process.

FIG. 9A and FIG. 9B show the steps in a multi-silo orchestration.

FIG. 10 shows a web service embodiment.

### DETAILED DESCRIPTION OF THE INVENTION

Disparate legacy systems running on internal IT platforms within organization with differing regional practices are impeding progress toward dissemination of critical medical data and straight through processing (STP). Hence, a means is needed to facilitate the processing of multiple vendor digital credential solutions from the front end to the back end. Thus facilitating the automated processing time, reducing administrative cost and the reduction in paper handling by converting to electronic records. The present disclosure provides this means.

The present disclosure provides a system and method which gives an end user, machine, or program access to discrete data elements and values by asserting an identity. In combination with appropriate attributes, the authentication enables the ability to process, authorize, and audit such things as data elements and values necessary to complete or run the application.

The system and method, in one embodiment called the OR Medical Application Platform (ORMAP), enables an understanding and management of various existing medical messaging systems, digital credentials and processing solutions. ORMAP will utilize standards such as HL7 Clinical Document Architecture (CDA), Continuity of Care Document (CCD), or the like. Also, ORMAP can use XDS.a, XDS.b, or the like as request standards to enable health care providers to search for and retrieve clinical documents from across multiple participating sources. Through the use of appropriate patient and provider identification, the ORMAP will utilize existing authentication and authorization standards to assist providers in both ambulatory and inpatient settings to obtain critical health information necessary to assess, stabilize, and treat patients.

The system and method of the business model depends on building collaborative partnerships with hospitals, public health organizations, doctor offices, small healthcare providers and clinics within the state of Michigan and then nationally. The exchange of “paper” for “electronic” is viewed by most providers as a means to reduce administrative costs and automated processing of confidential medical data. The real question is how to transmit data in a standard format or allow for conversion of the data elements and values appropriate to a query and do that in a trusted computing environment.

Current medium-term objectives are to:

1) Facilitate the exchange of health information across multiple hospitals, public health organizations, doctor offices, small healthcare providers and clinics and supporting the data needs of physicians, healthcare entities, emergency medical systems, patients, employers and healthcare payers.

2) Provide a true agnostic Internet gateway to bridge existing Electronic Data Interchange (EDI) “Claims” processing and proprietary systems. Offers private and secure digital bridge to expand the revenue cycle and healthcare management process to promoting the convergence among healthcare organizations, Clearinghouses and Financial Institutions (FIs).

3) Provide a comprehensive interoperable payment platform to assist Financial Institutions (FIs) with the integration and adoption of new and existing payment schemes regardless of payment infrastructure, security/identity credentials or proprietary vendor platform.

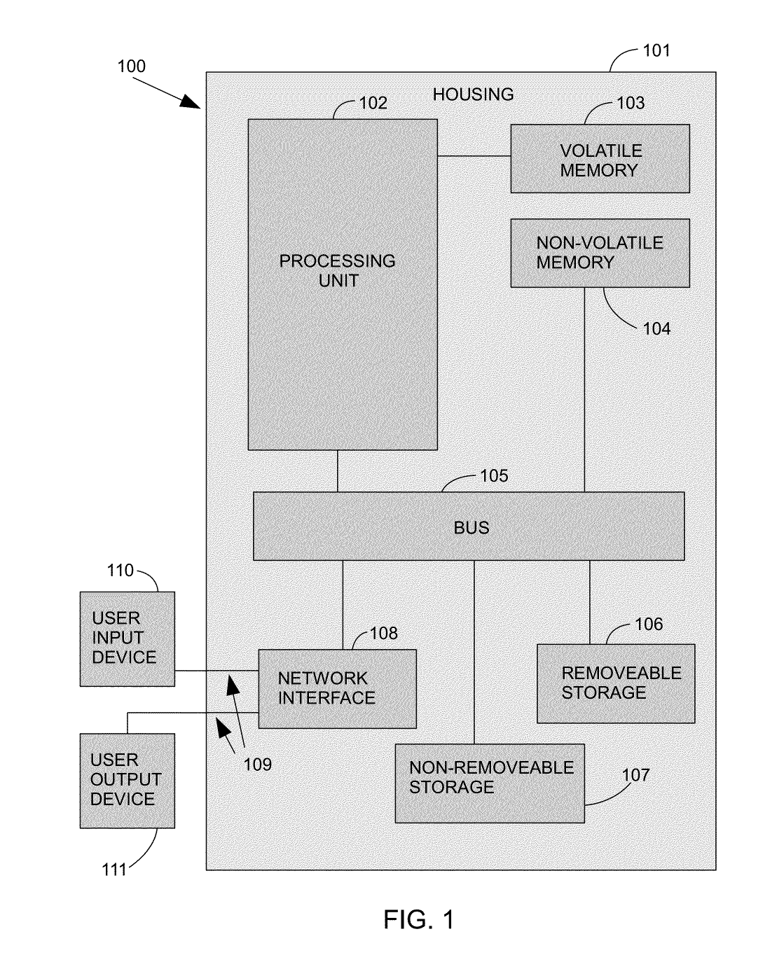

FIG. 1 is a block diagram of a typical computing environment used for implementing embodiments of the present disclosure. FIG. 1 shows a computing environment 100, which can include but is not limited to, a housing 101, processing unit 102, volatile memory 103, non-volatile memory 104, a bus 105, removable storage 106, non-removable storage 107, a network interface 108, ports 109, a user input device 110, and a user output device 111.

Various embodiments of the present subject matter can be implemented in software or applications, which may be run in the environment shown in FIG. 1 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types, iPods, and iPads), laptop devices, tablet devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices. Internet connectivity includes 802.11, LAN network, dial-up network, mobile cellphone networks, cable internet, DSL, and satellite base Internet.

On the mobile Operating System (OS) platform, it supports Android from Google Inc., bada from Samsung Electronics, BlackBerry OS from RIM, iOS from Apple Inc., S40 (Series40) from Nokia, Symbian OS from Nokia and Accenture and Windows Phone from Microsoft.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, program logic controller (PLC), field programmable gate array (FPGA), or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

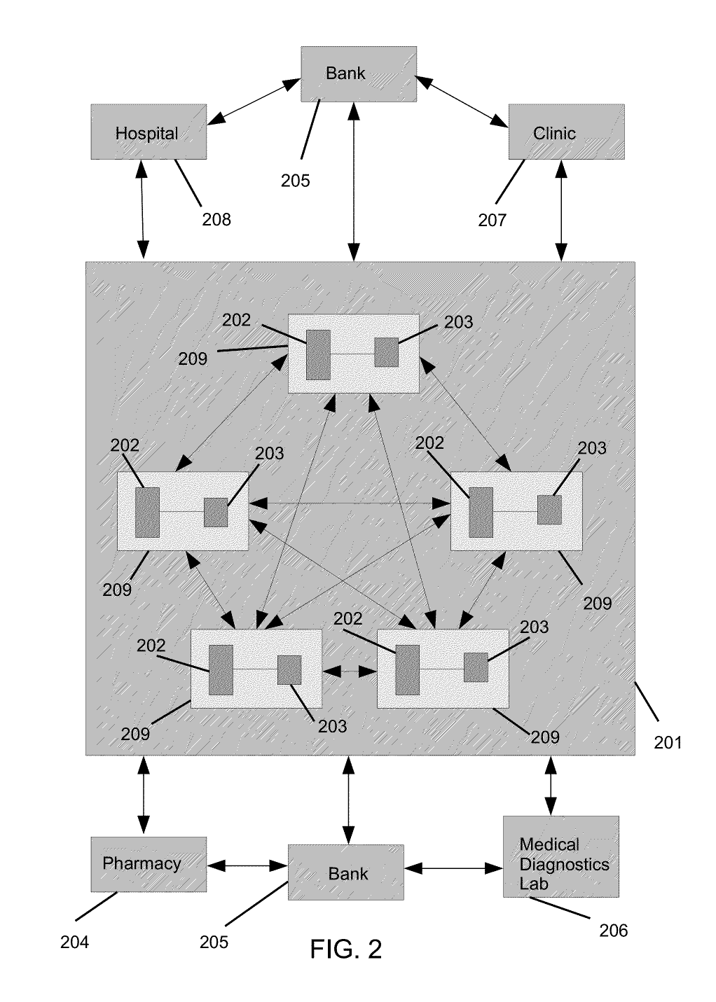

FIG. 2 shows a higher level view of the interaction between multiple institutions. OR and OR servers retain the central role as facilitator. A distributed control system 201 comprises nodes 209 configured with individual servers 202 and OR Tech gateways 203. The servers 202 within the distributed control system 201 maintain communication with each other. Communications outside of the distributed control system 201 is facilitated through the OR tech gateways 203. Outside entities can be pharmacies 204, financial institutions 205, medical diagnostics labs 206, clinics 207, hospitals 208, or the like. The data shared can be remittance information, medical payments, medical data, or the like.

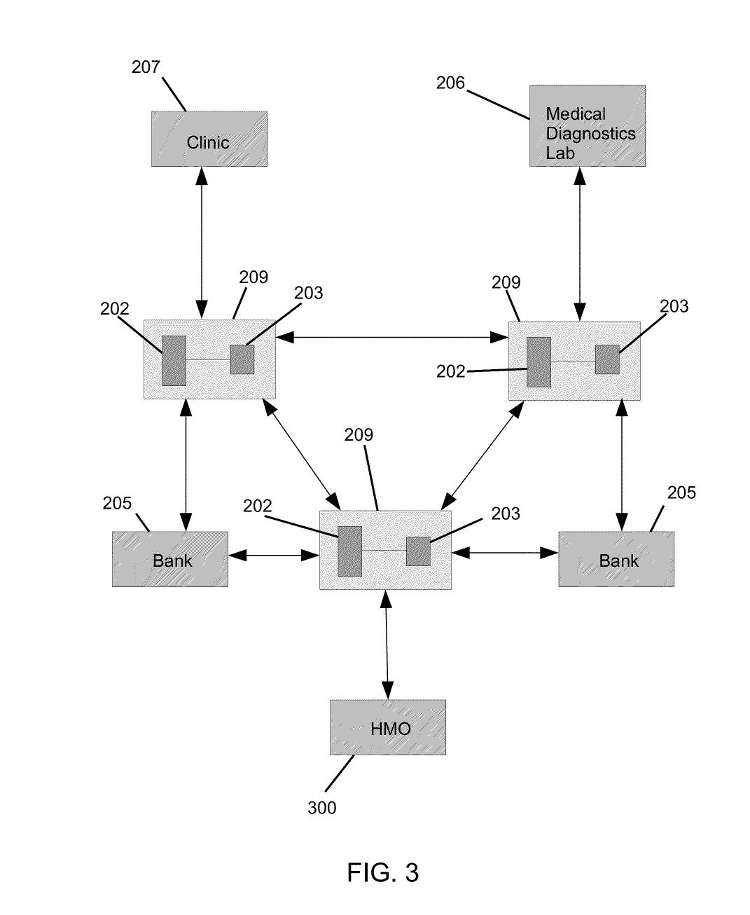

FIG. 3 shows in-depth architectural interaction between multiple institutions. In one embodiment, the steps can be: 301a patient sees a doctor in a clinic 207; 302 the doctor determines that an X-ray is needed; 303 the clinic's Networked Node locates the closest lab 206 for the patient; 304 patient initiates co-pay via payment service provider; 305 clinic's HIE node transfers patient payment and insurance information; 306 patient undergoes the prescribed X-ray; 307 lab's HIE node bills the patient's insurance company 300; 308 patient initiates co-pay via payment provider; 309 HMO receives service information; 310 upon approval, HMO 300 pays lab 206 and clinic 207 via payment service provider. In one embodiment, ORMAP connects to web services used by institutions, such as web services using SOAP for message encapsulation.

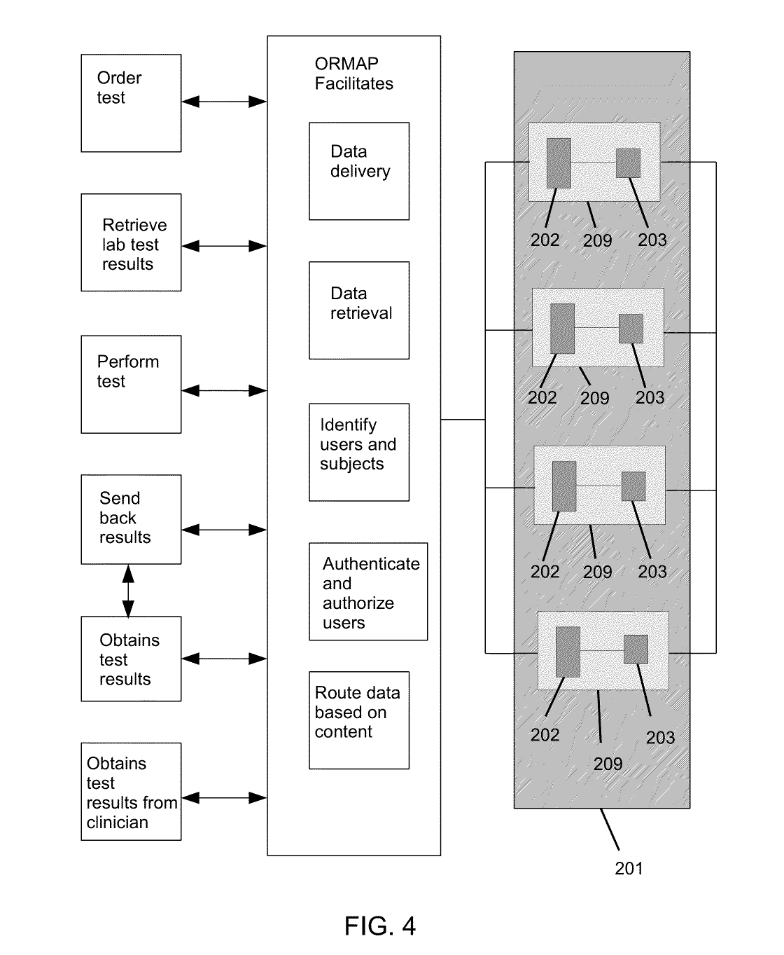

FIG. 4 CLINICAL MESSAGING: This use case is predicated on the Clinician's ability to use any web enabled device to order laboratory tests and retrieve patient test results from any authorized “Test” laboratory. ORMAP in this scenario facilitates the credential authentication process, thus allowing the ordering physician critical patient information and a crucial communication link between providers in both inpatient and outpatient settings.

The ORMAP application can be deployed to provide authorized medical employees:
1. Laboratory ordering and results from laboratory service providers.
2. Radiology ordering and reports from radiology service providers.
3. Admissions notifications and discharge summaries from hospitals and other ADT encounter data.
4. Encounter information and physician notes from outpatient facilities.
5. Diagnoses, results and physician notes required to facilitate referrals, consults and transfers in care including:
   A) To and from acute care hospitals
   B) Skilled nursing facility
   C) Rehabilitation facility
   D) Home health services
   E) Between primary care and specialty services Between physical and behavioral health service

Clinical Messaging Steps (FIG. 4):
1. The clinician initiates an XDSb query against via the wireless Internet.
2. OR Tech Systems wireless Healthcare Information Exchange (HIE) forwards the request.
3. OR Tech Systems wireless HIE forwards the message to the clinician's HIE.
4. Clinician's HIE routes the message to the laboratory's HIE.
5. Laboratory's HIE sends message back to the Laboratory via OR Tech Systems wireless HIE.
6. The Laboratory sends back the test results to its own dedicated HIE via OR Tech Systems wireless HIE.
7. Laboratory HIE forwards the test results to its own dedicated HIE via OR Tech Systems wireless HIE.
   A) Clinician requests tests results from its dedicated HIE via OR Tech Systems wireless HIE.
8. Consumer requests test results from the clinician's HIE via OR Tech Systems wireless HIE.
9. The clinician's HIE responds back to the clinician and consumer with test results via OR Tech Systems wireless HIE.

The OR Medical Application (ORMAP) will allow providers to search and retrieve clinical documents from across multiple participating sources. Through the use of appropriate patient and provider identification, the ORMAP healthcare information exchange (HIE) would assist providers, in both ambulatory and inpatient settings in obtaining critical health information related to assess, stabilize and treat patients in an emergency incident. This use case scenario illustrates the means by which OR Tech Systems' ORMAP middleware plug-in application provides a pass through credential authentication mechanism that allows users access to the following types of results:
tab reports from laboratory service providers
Radiology reports from radiology service providers
Discharge summaries from hospitalizations and Emergency Department (ED) visits
Treatment encounter data—admission dates, discharge dates, and other abstract data type (ADT) information
Encounter information and physician notes from outpatient facilities
Information on patient's known allergies
Immunization records
Prescription drug histories from the following potential sources: Payers/PBMs (Pharmacy benefit management), Pharmacies, Hospitals/providers and RxHub/SureScripts/other clearing houses

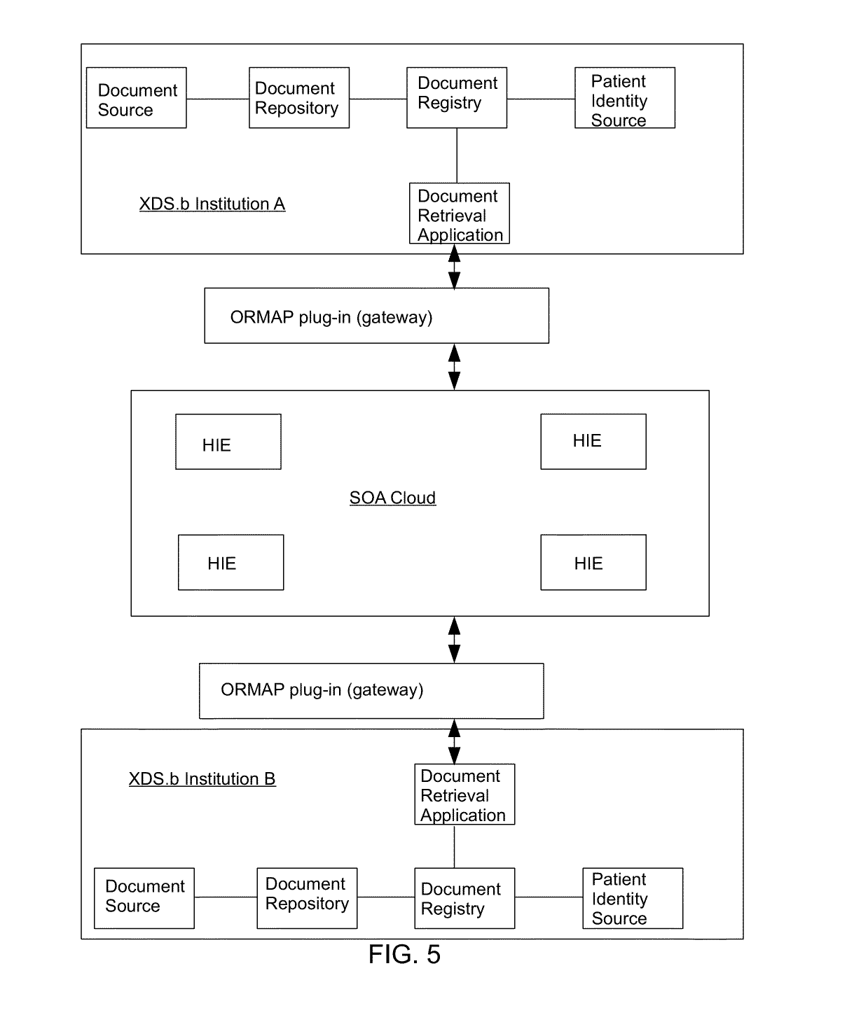

FIG. 5 shows the use of the ORMAP plug-in facilitating information sharing between two institutions running XDS.b standard for medical document query and retrieval. 1) An application at Institution A utilizing the ORMAP plug-in indicated that it needs a document from Institution B. 2) ORMAP communicates the document request to Institution A's HIE. 3) Within the SOA cloud consisting of interconnecting HIE, one of the OR Tech servers receives the document request and reroutes it to the HIE connected to Institution B. 4) ORMAP plug-in at Institution B contacts the application to make the document query. 5) The application receives the document query from ORMAP plug-in and makes the document request on behalf of the user from Institution A. 6a-d) The XDS.b components will parse the document request query and return the requested documents to the application. 7) The application receives the documents and forwards it to the ORMAP plug-in. 8) ORMAP plug-in forwards back the query results back to Institution B's HIE. 9) One of the OR Tech Servers reroutes the query results back to Institution A's HIE. 10) OR Tech plug-in receives the document query results and forwards them to the application. 11) The application renders and displays the document query results.

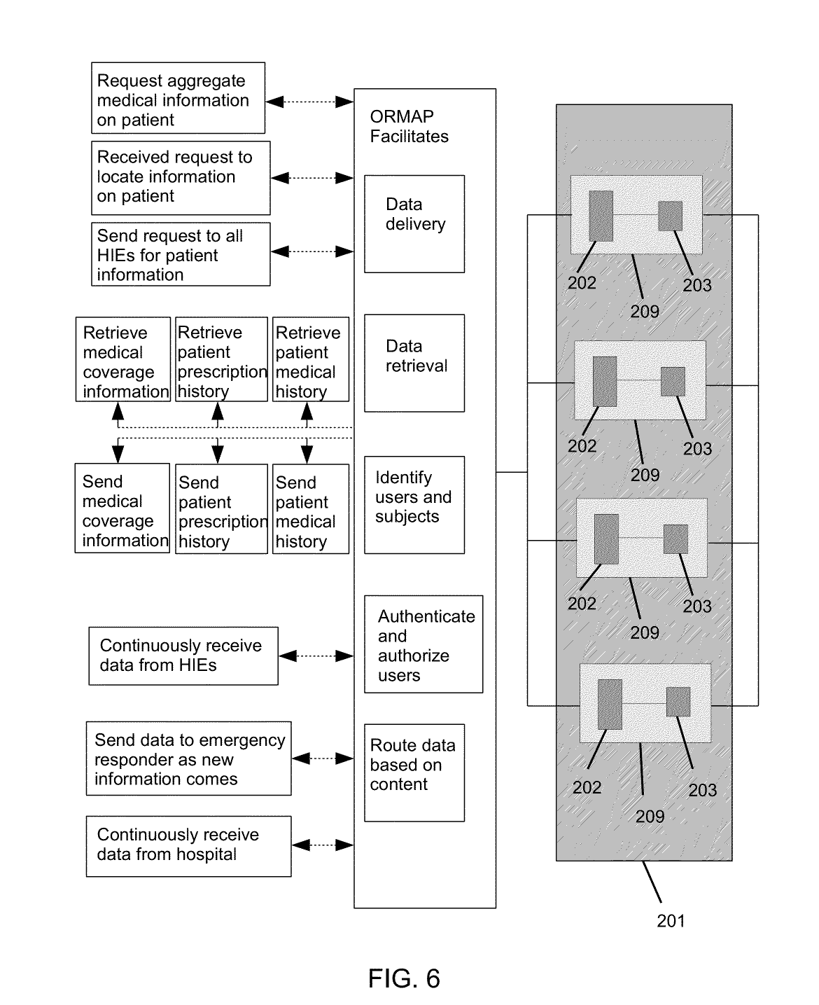

FIG. 6 shows a high level view of clinical results retrieval embodiment among actors in the medical field. Each item represents a document query as explained in detail in FIG. 5. 501 The emergency clinician is on the site of the incident and requests medical information on the injured patient via a mobile device connected to the OR Tech Systems HIE. 502 OR Tech Systems HIE forwards the request to the emergency clinician's HIE. 503 The destination hospital retrieves the request to obtain the injured patient's complete medical information. 504 The hospital sends a broadcast to all the HIEs via OR Tech Systems HIE. 505 The individual HIEs receive the request on the patient. 506 The information is sent back to the medical payer, clinician and pharmacy (other critical medical systems) via OR Tech Systems HIE. 507 Medical payer, clinician and pharmacy receive the information request. 508 Medical payer, clinician and pharmacy locate all pertinent patient information and responds back with the requested information to its corresponding HIE. 509 The individual HIEs will forward the information back to the requesting hospital. 510 The hospital continuously gathers up the patient's information as it arrives in real-time from the different HIEs via the OR Tech Systems HIE. 511 The hospital sends up-to-date information back to the emergency clinician's mobile device via the OR Tech Systems HIE. 512 The emergency clinician's mobile device receives the information from the hospital via the OR Tech Systems HIE.

APPLICATION INTEGRATION MODEL: OR Tech Systems recognizes that establishing a collaborative partnership with medical institutions, Internet Service Providers (ISPs), mobile Operating System (OS) developers, and Financial Institutions (FIs) servicing smartphones is critical. OR Tech Systems also recognizes that the proliferation of multiple payment and healthcare services is advantageous in promoting the value of our proprietary solution. As a central facilitator of data that merely passes through credential information and input parameters to SOAP and REST services and return results back to the caller, OR Tech Systems must establish a symbiotic relation with emerging and existing healthcare and payment service providers. In one embodiment, the ORMAP plug-in will pass through credential and input parameters to the services needed and return results from the institution.

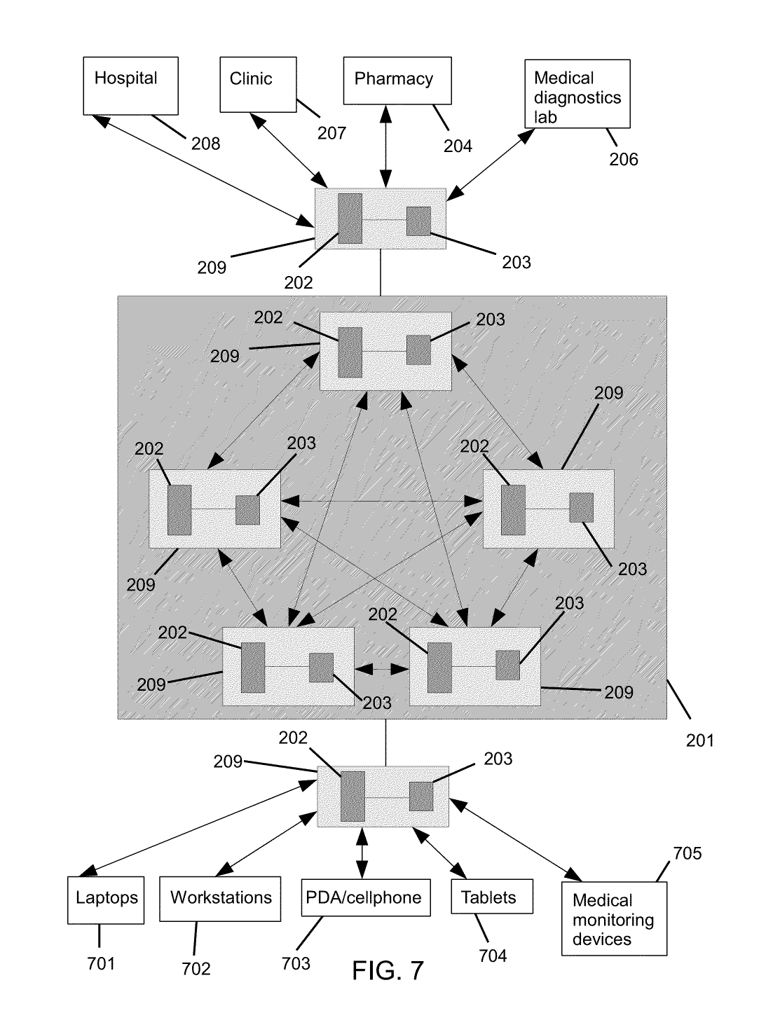

FIG. 7 shows an embodiment of high level architecture. A distributed control system 201 comprises nodes 209 configured with individual servers 202 and OR Tech gateways 203. The servers 202 within the distributed control system 201 maintain communication with each other. Communications outside of the distributed control system 201 is facilitated through the OR tech gateways 203. Entities shown communicating with the distributed control system 201 are a hospital 208, clinic 207, pharmacy 204, medical diagnostics lab 206, laptops 701, workstations 702, PDA/cellphone 703, tablets 704, and medical monitoring devices 705.

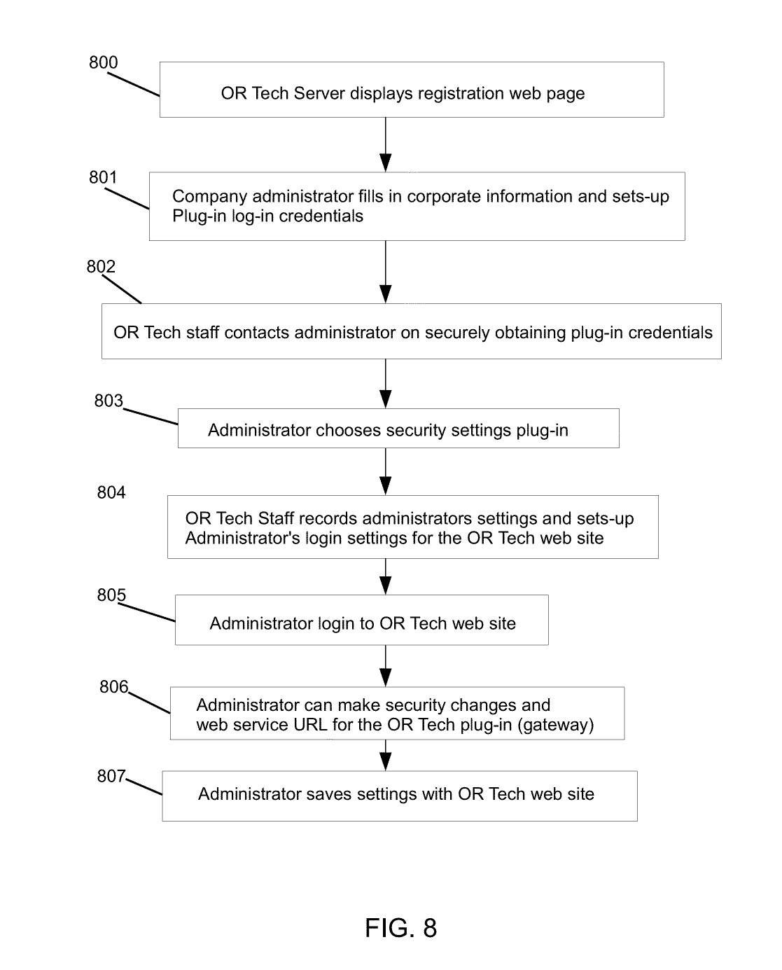

COMPANY REGISTRATION PROCESS: FIG. 8 shows the steps in a company registration process. 800 When a company wants to use the OR Tech plug-in software, it has to register with the OR Tech Server with its information. 801 The company's administrator goes to OR Tech's web site and enters information about the company. 802 OR Tech receives the company information and contacts the administrator on how to securely download OR Tech plug-in XML (Extensible Markup Language) credential file. 803 The Administrator tells OR Tech staff the following

a. What credential type the OR Tech plug-in uses to contact OR Tech Server. ORMAP will become the relying partner that lets the institution take full control over which credential type to use.

b. What external companies are allowed to contact this company

c. The credential types needed for external users.

d. URL (uniform resource locator) for the web service for use by outside users.

e. External user's session lifetime

804 OR Tech records administrator's settings and sets up a web login for the administrator. 805 At any time the administrator can go into the OR Tech website using new credential from OR Tech Staff 806 Administrator can make security changes and enter the web service URL for the web service. 807 Administrator saves changes with OR Tech server.

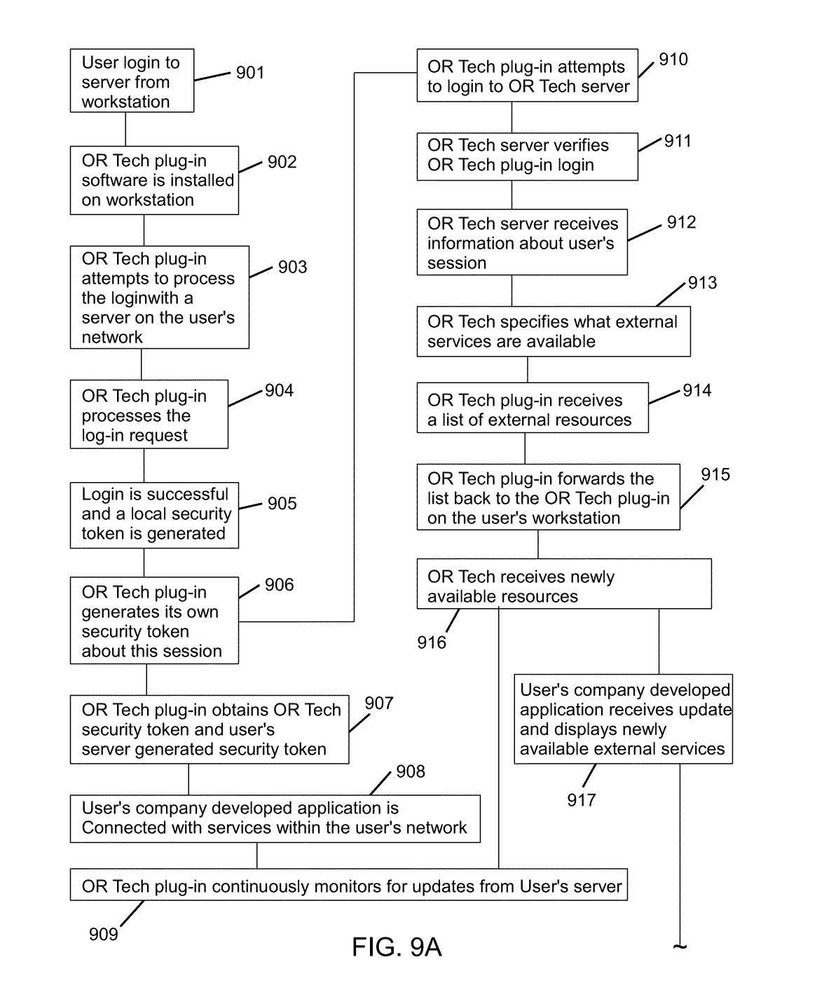

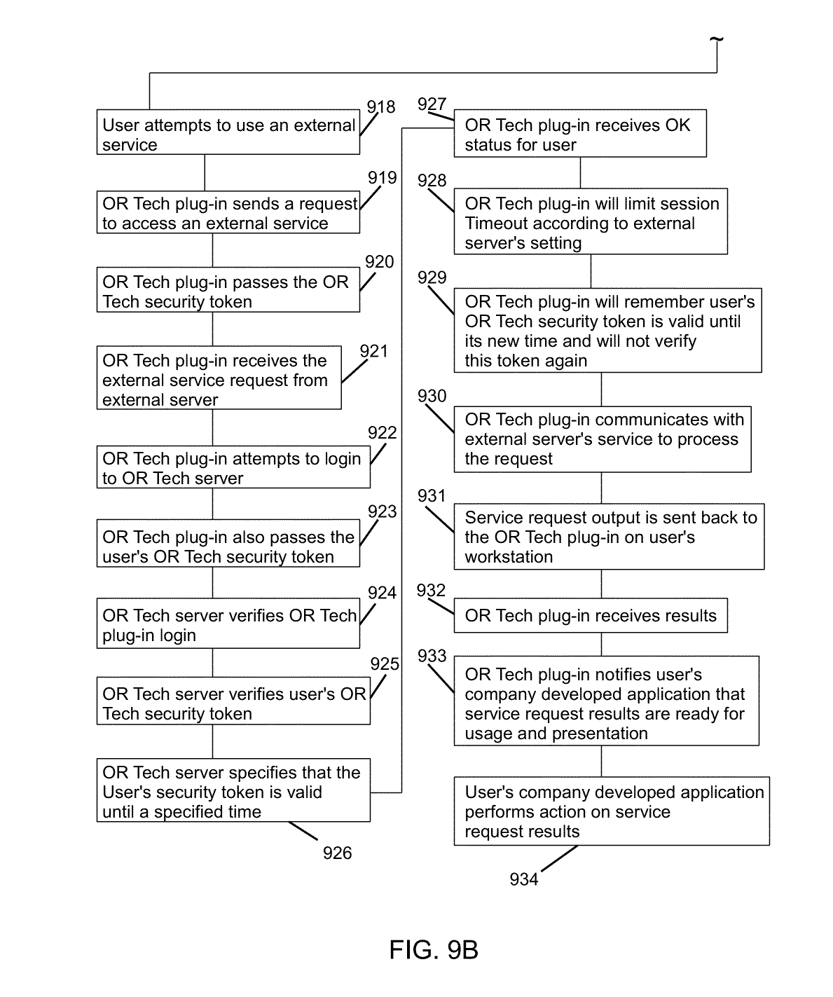

MULTI-SILO ORCHESTRATION: FIG. 9A and FIG. 9B show the steps in a multi-silo orchestration. 901 User accesses a computer with his corporate login. 902 The OR Tech plug-in software is installed on this user's workstation. 903 User logs in to his company's server. The OR Tech plug-in software will take user's credentials and attempt to perform the login by sending it to the user's server. 904 OR Tech plug-in (also known as a gateway) installed on user's server processes user's credentials for this login. 905 User's server software authenticates the user and generates its own security token with a specified session lifetime. 906 OR Tech plug-in on user's server generates its own security token. This token will contain user's externally addressable location, company information, credential type used and session lifetime. 907 OR Tech plug-in on user's workstation receives both security tokens. 908 User's company developed application can use the server generated security token to access services on the server. 909 OR Tech plug-in on user's workstation continues to wait from user's server about available external services for the user's company developed application to use. 910 OR Tech plug-in on the user's server attempts to login to OR Tech Server (also known as an administrative server). It passes its own credentials and the OR Tech security token for the user. 911 OR Tech Server verifies credentials from user's server's OR Tech plug-in. 912 If credentials are valid OR Tech server will record user's session information. 913 OR Tech server will lookup policies setup by all the registered companies and determine which companies' services are available for this user based on information from the OR Tech security token generated by user's server's OR Tech plug-in. 914 OR Tech plug-in on user's server receives the list of available resources for this user. 915 This list is forwarded to the OR Tech plug-in on user's workstation. 916 OR Tech plug-in on user's workstation receives the list and notifies user's company developed application. 917 User's company developed application receives the update and displays the newly available external services. 918 User attempts to use one of the listed external services. 919 OR Tech plug-in on user's workstation sends a request to access an external service. 920 This external service request will contain the OR Tech security token generated by the user's server's OR Tech plug-in. 921 OR Tech plug-in on the external server receives the external service request. 922 OR Tech plug-in on the external server attempts to login to OR Tech server. 923 In this login process the OR Tech plug-in on external server passes the OR Tech security token from the user external service request. 924 OR Tech Server verifies credential from the external server. 925 If the credentials are valid, it will perform a lookup if this incoming OR Tech security token is valid. 926 If user's OR Tech security token is valid it will reset the session lifetime to the minimum length between the value set by user's server and the value configured by the administrator of the external server. 927 OR Tech plug-in on the external server receives OK status for the user. 928 OR Tech plug-in on the external server will adjust the session lifetime to the minimum length between the value set by the external server and the value returned by OR Tech Server. 929 OR Tech plug-in on the external server will remember that user's OR Tech security token is valid until the final computed session lifetime value and will not verify this security token again. 930 OR Tech plug-in on the external server will communicate with the service handler to perform the designated task with the user specified parameters. 931 The output of the request is sent back to the OR Tech plug-in on the user's workstation. 932 OR Tech plug-in on user's workstation receives the service request output. 933 OR Tech plug-in on user's workstation notifies user's company developed application that service request results are available for usage and presentation. 934 User's company developed application performs action on the service request results.

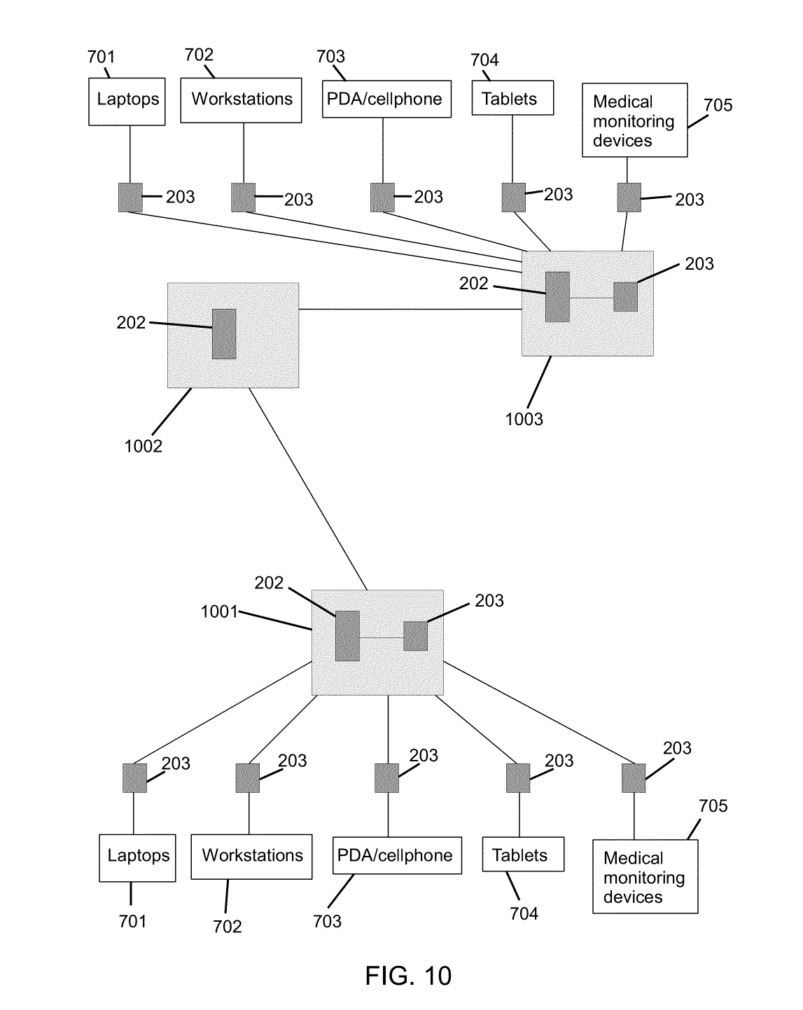

FIG. 10 shows a web service embodiment. One method embodiment can comprise the following steps: 1) User is activating an application on the device of choice (701, 702, 703, 704, or 705). 2) User logs into the company's internal server 1001 via an OR Tech plug-in (gateway) 203. 3) The internal server 1001 processes the user login and sends back the login result. 4) Login is successful and an application on the internal server 1001 talks to the ORMAP plug-in 203 to obtain a list of external institutions 1003 that are connectable to this institution 1001. 5) ORMAP plug-in 203 on the user's device (701, 702, 703, 704, or 705) and forwards the request to the ORMAP plug-in installed on the Internal Server. 6) ORMAP plug-in 203 on the Internal Server 1001 connects to the OR Tech Server Node 1002 (which can be hosted by a generic web service) to obtain a list of connectable external institutions' web services 1003. 7) OR Tech Server 1002 returns a list institutions and web services 1003 available back to the ORMAP plug-in 203 at the Internal Server 1001. 8) ORMAP plug-in 203 at the Internal Server 1001 receives the list and forwards it to the ORMAP plug-in 203 at the user's device (701, 702, 703, 704, or 705). 9) ORMAP plug-in 203 at the user's device (701, 702, 703, 704, or 705) communicates with the application to display the list of services available. 10) The user selects the web service to use. The application render a UI interface to allow the user to enter the require information to execute the desire command on the selected web service. 11) The ORMAP plug-in 203 at the user device (701, 702, 703, 704, or 705) receives the input parameters for the selected web service command from the application and forwards them to the ORMAP plug-in 203 at the Internal Server 1001. 12) ORMAP plug-in 203 at the Internal Server 1001 forwards the request to the OR Tech Server Node 1002. 13) OR Tech Server Node 1002 receives the request. 14) OR Tech Server Node 1002 forwards the request to the ORMAP plug-in 203 at the server 202 running the External Web Service 1003. 15) The External Web Service 1003 receives the request from its ORMAP plug-in 203 and executes the desired action. 16) The results of the desired action are sent back to ORMAP plug-in 203. ORMAP plug-in 203 forwards the results back to the OR Tech Server Node 1002. 17) OR Tech Server Node 1002 receives the results. 18) OR Tech Server 1002 forwards the received results back to the Internal Server 1001. 19) ORMAP plug-in 203 at the Internal Server 1001 receives the results. 20) ORMAP plug-in 203 at the user's device (701, 702, 703, 704, or 705) receives the results and communicates them with the application. 21) The application renders the results for the user.

In a separate embodiment, the prior method can further comprise steps to enable the External Web Service 1003 to exchange data with devices such as laptops 701, workstations 702, PDA/cellphone 703, tablets 704, and medical monitoring devices 705. This shared data can then be shared as previously described to enable the user's device (701, 702, 703, 704, or 705) which is communicating with Internal Server 1001 to receive the data. Conversely, data can travel in the other direction. Hence, devices such as laptops 701, workstations 702, PDA/cellphone 703, tablets 704, and medical monitoring devices 705 can exchange data via their respective ORMAP plug-in 203 and node 209 (which comprise a server 202 and ORMAP plug-in (gateway) 203.

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

We claim:

1. A system that facilitates confidential medical records access on agnostic internet accessible applications, the system comprising:
a plurality of nodes, wherein each node comprises a server configured for data storage and a communication gateway, each gateway is configured to communicate to other gateways of other nodes utilizing a HL7 Clinical Document Architecture, and each node is configured to transmit, receive, or both transmit and receive confidential medical records via the node's respective gateway.

2. A method to facilitate the access of confidential medical records on agnostic internet accessible plug-in applications, the method comprising:
communicating via a plurality of nodes, wherein each node comprises a server configured for data storage and a communication gateway, each gateway is configured to communicate to other gateways of other nodes utilizing a HL7 Clinical Document Architecture, and each node is configured to transmit, receive, or both transmit and receive confidential medical records via the node's respective gateway.

3. A method to facilitate the access of confidential medical records on agnostic internet accessible plug-in applications, the method comprising:
activating a computing environment which is configured with a first gateway capable of communicating via Clinical Document Architecture;
using the computing environment to log into a user's server;
generating a gateway compatible security token with the user's server;
using the gateway compatible security token to log into an administrative server, wherein the administrative server verifies a security token validity and enables communication with an external server; and
enabling the computing environment to exchange data with the external server via the user's server and the administrative server.

4. The method of claim 3, further comprising after the last step, enabling the computing environment to exchange data with an external computing environment, via the user's server, the administrative server, and the external server.

5. The method of claim 4, further comprising after the logging into the server step, having the administrative server receive information about the computing environment and specify a list of external services which are available on a plurality of other external servers.

6. The method of claim 5, further comprising after the having the administrative server receive information step, receiving the list of external services which are available on a plurality of other external servers via the gateway and transmitting the list to the computing environment.

7. The method of claim 4, wherein the external server is configured with a second gateway capable of communicating via Clinical Document Architecture.

8. The method of claim 7, further comprising after the using the gateway compatible security token step, specifying a time limit for the security token validity with the administrative server.

9. The method of claim 8, wherein the second gateway is configured to cancel communications if the time limit is exceeded.
